(19) United States
(12) Patent Application Publication
(10) Pub. No.: US 2002/0008014 A1
(43) Pub. Date: Jan. 24, 2002

(54) High voltage treatment equipment and method for liquid

(75) Inventors: Shigeto Adachi, Takasago-shi (JP); Shinzo Iida, Takasago-shi (JP); Junji Haga, Takasago-shi (JP); Masahiko Miura, Kobe-shi (JP); Yoshiyuki Hosokawa, Kobe-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Kobe Seiko Sho (Kobe Steel, Ltd.), Kobe-shi (JP)

(21) Appl. No.: 09/884,115

(22) Filed: Jun. 20, 2001

(30) Foreign Application Priority Data
Jun. 21, 2000 (JP) 2000-186493
Sep. 12, 2000 (JP) 2000-277178

(51) Int. Cl. B01J 19/08; H05F 3/00

(52) U.S. Cl. 204/164; 422/186.04; 422/186.21; 422/186.26

(57) ABSTRACT

To provide a high voltage treatment equipment in which even if a voltage applied between a pair of electrodes is lowered to not more than a predetermined value, field strength is produced between the pair of electrodes, a discharge having a wide spread is formed and liquid can be reformed with high efficiency, and economically advantageously.

A liquid treatment equipment comprising at least a pair of electrodes, wherein at least one electrode is arranged so as to be dipped into liquid, and a pulsed power is applied between the pair of electrodes to form a discharge state between the electrodes to thereby reform liquid present between the electrodes, wherein a region having field strength raised to a value not smaller than 500 kV/cm is present in the vicinity of the electrode dipped into the liquid. To this end, the electrode dipped into the liquid is in the form of a rod, whose diameter is not more than 1 mm φ.

Further, operation is carried out, while moving at least one electrode out of a set of a pair of electrodes, by changing a discharge generation part on the moving electrode.

Furthermore, a liquid treatment equipment wherein a treated liquid is supplied into a pipeline continuously or intermittently, and a discharge state is formed between a ring-like or tubular electrode arranged coaxially with the inner peripheral surface of the pipeline and a linear electrode arranged along the axial center of the pipeline to reform the treated liquid within the pipeline, wherein the ring-like or tubular electrode is embedded in the pipeline wall leaving the inner surface of the electrode.

### BACKGROUND OF THE INVENTION

1. Field of the Invention

The present invention relates to equipment used for carrying out (1) biochemical aerobic treatment or anaerobic treatment of organic waste water discharged during sewage treatment in sewage treatment plant or night soil treatment plant or during drainage in food plant or chemical plant; (2) sterilization/bacterial treatment, decoloring treatment, and deodorization treatment of waster water (including also those other than organic waste water) in the above-described plants, treated water during producing clean pure water or water supply and drainage and food or drinking water; or (3) decomposition treatment of noncomposition materials such as dioxins, endocrine disrupters, PCBs and the like appeared during the sterilization/bacterial treatment, decoloring treatment, and deodorization treatment of the above-described various liquids or during effluent seepage of decoction in a refuse incinerator.

2. Background of the Related Art

In various uses described in the above-described (1) to (3), for example, as a method for perishing toxic bacteria contained in liquid to clean the liquid, or as a method for reforming, for reducing bacteria contained in liquid or contaminated components such as a dead body thereof, the contaminated component into a state that aerobic microbe can be easily treated biochemically, there is known a so-called high voltage treatment method for applying pulsed power discharge treatment and or field pulse to the liquid to treat the liquid, wherein “pulsed power” means high voltage pulse. The present inventors have proposed, for example, such as Japanese Patent Application Laid-open No. Hei 11-253999 as a high voltage treatment method and equipment therefor.

FIG. 1 is a schematic diagram showing a constituent example of the high voltage treatment equipment proposed previously by the present inventors. This equipment handles organic waste water as object liquid (treated liquid).

In the equipment shown in FIG. 1, a part of precipitated polluted sludge 10 is introduced from a channel 12 into a reforming tank 3 of a reforming device 18 by a pump 17. The reforming device 18 is provided with a reforming tank 3 and a power supply 4, and a rod electrode (anode) 5 and a planar electrode (cathode) 6 connected to the power supply 4 are arranged in parallel so that they are dipped into the sludge in the reforming tank 3. The sludge (the precipitated sludge 10 introduced from a precipitator 2) in the reforming tank 3 can be regarded as dielectric showing a predetermined electric constant electrically, and when in the state that the dielectric is filled between the pair of electrodes 5 and 6, voltage is applied to carry positive and negative charges to the electrodes 5 and 6, respectively, an electric field is formed in the dielectric (sludge), and when the strength of the electric field exceeds a certain degree, dielectric breakdown occurs to generate discharge between the electrodes 5 and 6.

By the pulsed power discharge treatment between the electrodes 5 and 6 as described above, the precipitated sludge becomes soluble and lower in molecule (reformed).

Normally, as high voltage is applied between the electrodes dipped into liquid, a suitable high electric field is formed between the pair of electrodes, and a so-called primary avalanche is formed. In the avalanche course of the primary avalanche, some residual negative ion (a group of negative ions) are generated by the adhesion action between an electron and a positive ion. An electric charge amount in liquid is a predetermined amount of space electric charge comprising the sum of the residual negative ion and the electric charge which has been present. The electric field in liquid becomes a combined electric charge comprising a combination of an electric field formed from the space electric charge and an applied electric charge of high voltage applied between the pair of electrodes.

As the combined electric field sufficiently becomes high, an electron generated by optic ionization during progress of the primary avalanche grows as a secondary avalanche toward the center of gravity of the group of residual ions. Thin-shaped plasma is formed by the primary and secondary avalanches. This is a phenomenon called a streamer (discharge).

The streamer discharge is not always maintained in a stabilized state but may be sometimes changed to a different discharge state as the case may be. For example, sometimes, the thin streamer discharge is changed to a different form of discharge such that a light column is formed between the pair of electrodes. Such a change as described, naturally, greatly depends upon how the streamer discharge propagates between the pair of electrodes.

Incidentally, for forming the streamer discharge as described above and generating the streamer discharge widely, it is necessary to generate field strength greater than 500 kV/cm between the pair of electrodes. Further, for meeting the demand that the treatment amount of liquid of treated substance should be increased, widening the distance between the pair of electrodes is contemplated as a solution, but since the distance between the pair of electrodes influences on the field strength, it is also necessary for increasing voltage applied between the electrodes.

Increasing voltage applied between the electrodes results in preparing a high voltage power supply capable of outputting suitable high voltage, but when that output exceeds approximately 150 kV, more strictly, 100 kV, microcorona tends to generate in an insulator formed of resin or the like in the high voltage power supply, thus making it necessary to take countermeasures such as restricting an insulator employed or making size of the high voltage power supply large. This poses a problem that costs are disadvantageous, and the economic point becomes worse.

### SUMMARY OF THE INVENTION

The present invention has been accomplished in view of the actual situation as described above. A first object of the present invention is to provide a high voltage treatment equipment in which even if voltage applied between electrodes is lowered to not more than predetermined value (for example, not more than 100 kV), sufficient field strength is generated between electrodes, and discharge having a wide extent is formed, and liquid can be reformed with high efficiency as well as economically advantageously.

Further, a second object of the present invention is to provide a liquid treatment method and equipment therefor in which when pulsewise electric power is supplied between electrodes to reform liquid present between electrode, stabilized discharge for a long period of time can be supplied.

Further, a third object of the present invention is to provide liquid treatment equipment in which when pulsewise electric power is supplied between electrodes to reform liquid present between electrode, even if operation is continued over a long period of time, stabilized discharge can be supplied without pressure loss of treated liquid caused by electrodes or adhesion of dust.

The high voltage treatment equipment according to the present invention capable of achieving the aforementioned first object is liquid treatment equipment in which at least a pair of electrodes are provided, at least one electrode out of the pair of electrodes is arranged so as to be dipped into liquid, and a pulsed power is applied between the electrodes to form a discharge state between the electrodes whereby liquid present between the electrodes is reformed, wherein a region having been enhanced to a value greater than 500 kV/cm of field strength is present in the vicinity of the electrode dipped in the liquid.

In the high voltage treatment equipment according to the present invention, voltage of the pulsed power applied between electrodes is not more than 100 kV, and the electrode dipped in liquid is a rod-like electrode whose diameter is not more than 1 mm φ. Further, preferably, the extreme end of the rod-like electrode dipped in liquid is formed to be a hemisphere.

Incidentally, in the high voltage treatment equipment according to the present invention, at least one electrode out of the pair of electrodes is dipped into liquid whereby its treatment function can be exhibited, but from a viewpoint of maintaining the discharge state better, preferably, the electrode dipped in liquid is at least an anode electrode, more preferably, both cathode electrode and anode electrode are dipped.

While the present invention is constituted as described above, it is noted in short that the diameter of the rod-like electrode is set as small as possible, not more than a predetermined amount whereby even if power voltage is not raised to a predetermined amount or more, the field strength is increased to be more than 500 kV/cm, and the streamer discharge can be extended widely. Further, by employment of the constitution as described, not only a power supply for supplying low voltage can be used, but also the streamer discharge is enlarged widely whereby the discharge treatment region is widened to increase the treatment amount per unit energy and lower energetic waste.

Incidentally, in reforming liquid by the streamer discharge, a leaky current sometimes flows to liquid during discharge. Such a leaky current results in Joule loss not only to raise a water temperature of treated liquid but also to be wasteful in terms of energy. However, if the constitution of the present invention is employed, even such a leaky current can be reduced. That is, since a leaky current is determined by a potential applied between electrodes and an exposed area to treated water of electrodes (not affected by the field strength in the vicinity of electrodes), the diameter of the rod-like anode electrode is set to be small whereby the exposed area to the treated water is reduced, and the leaky current to the treated water is reduced to enable avoiding inconvenience as noted above.

The high voltage treatment equipment according to the present invention capable of achieving the aforementioned second object is liquid treatment equipment in which at least a pair of electrodes are provided, at least one electrode out of the pair of electrodes is dipped into treated liquid, and pulsewise power is supplied to the pair of electrodes to form a discharge state between the electrodes to reform the liquid present, the equipment comprising a mechanism wherein at least one electrode out of the pair of electrode can be moved so as to change a relative positional relationship with respect to the other electrode. Concretely, the electrode constituted to be movable out of the pair of electrodes is a rod-like or linear electrode, and the other is a ring-like or tubular electrode, and the rod-like or linear electrode is constituted to be movable through a center point or an axial center of the ring-like or tubular electrode.

Further, preferably, the end of the rod-like or linear electrode out of the pair of electrodes is present in the vicinity of the ring-like or tubular electrode, and the pair of electrodes are dipped into the treated liquid.

For making the rod-like or linear electrode movable, it is suggested that there may be provided means for feeding or pulling out the rod-like or linear electrode continuously or intermittently, or means for winding the rod-like or linear electrode continuously or intermittently.

Also, preferably, in the above-described equipment according to the present invention, there may be provided means for causing the treated liquid to flow continuously or intermittently, and means for controlling the flow of the treated liquid so that bubbles are not stayed in a discharge generation part of the electrode.

Further, the above-described equipment according to the present invention, there may comprise:

(1) means for measuring discharge voltage or discharge current to the treated liquid, and means for controlling movement of the electrode on the basis of variation of the discharge voltage or the discharge current measured;

(2) means for measuring flow rate or conductivity or impedance of the treated liquid, and means for controlling or stopping interval or applied voltage of discharge on the basis of variation of the value measured; and

(3) means for detecting bubbles present in a pair of electrode arrangement portion internally of the liquid treatment equipment, and means for stopping operation when judgment is made that the treated water is not present.

The high voltage treatment method according to the present invention capable of achieving the aforementioned second object is a liquid treatment method in which at least a pair of electrodes are provided, at least one electrode out of the pair of electrodes is dipped into treated liquid, and pulsed power is supplied to the pair of electrodes to reform the treated liquid, wherein the discharge generation part on the moving electrode is changed while moving at least one electrode out of the pair of electrodes. It is effective that the movement of the electrode is carried out continuously or intermittently, and it is further effective that such movement is carried out while flowing the treated liquid continuously or intermittently.

The high voltage treatment equipment according to the present invention capable of achieving the aforementioned third object is liquid treatment equipment in which treated liquid is supplied into a pipeline continuously or intermittently, and a discharge state is formed between a ring-like or tubular electrode arranged concentric with the inner peripheral surface of the pipeline and a linear electrode arranged along the axial center of the pipeline to reform the treated liquid in the pipeline, wherein the ring-like or tubular electrode is embedded in the pipeline wall leaving the inner surface of the electrode. Preferably, the ring-like or tubular electrode is constituted so that a plane part as viewed in an axial direction of the ring-like or tubular electrode is not substantially exposed inward from the pipeline inner wall.

Further, in the liquid treatment equipment according to the present invention, further effect can be obtained by the provision of constitution that a difference of diameter is not present in a connection part between the pipeline and a treated liquid inlet pipe and or a treated liquid outlet pipe.

### BRIEF DESCRIPTION OF THE DRAWINGS

FIG. 1 is a schematic diagram showing a constitutional example of the high voltage treatment equipment proposed previously by the present inventors;

FIG. 2 is a schematic diagram showing one example of an arrangement state of electrodes and a discharge state in the high voltage treatment equipment according to the present invention;

FIG. 3 is a plan view of an arrangement state of a rod electrode 25 and a plate electrode 26 as viewed from top;

FIG. 4 is a graph showing the influence of the diameter of the rod electrode 25 on a relationship between the distance from the electrode surface and the field strength;

FIG. 5 is an equipotential view showing distribution of field strength between the rod electrode 25 and the plate electrode 26 when the diameter of the electrode 25 is 1 mm φ;

FIG. 6 is an equipotential view showing distribution of field strength between the rod electrode 25 and the plate electrode 26 when the diameter of the electrode 25 is 10 mm φ;

FIG. 7 is a view for explaining the field strength between anode and cathode;

FIG. 8 is a graph showing a relationship between the distance from the electrode surface and the field strength when the end of the rod electrode is hemispheric;

FIG. 9 is a waveform view of a pulsed power applied when the discharge state is observed;

FIG. 10 is a schematic diagram showing an another example of the present invention;

FIG. 11 is a schematic diagram showing an another example of the present invention;

FIG. 12 is a schematic diagram showing an another example of the present invention;

FIGS. 13A and 13B are schematic diagrams showing other examples of the present invention;

FIG. 14 is a schematic diagram showing an another example of the present invention;

FIG. 15 is a schematic diagram showing an another example of the present invention;

FIG. 16 is a schematic diagram showing an another example of the present invention;

FIGS. 17A and 17B are schematic diagrams showing other examples of the present invention;

FIGS. 18A and 18B are schematic diagrams showing other examples of the present invention;

FIG. 19 is a schematic diagram showing an another example of the present invention;

FIG. 20 is a schematic diagram showing an another example of the present invention;

FIG. 21 is a schematic diagram showing an another example of the present invention; and

FIGS. 22A-1, 22A-2, 22B-1 and 22B-2 are plan views for explaining arrangements of the sectional shapes of pipelines and ring-like or tubular electrodes.

### DESCRIPTION OF THE PREFERRED EMBODIMENTS

While in the following, the constitution and operation/effect of the present invention will be described with reference to the drawings, it is to be noted that the present invention is not limited to the constitution illustrated in the following, but the change in design in the light of the foregoing and the following is included in the technical field of the present invention.

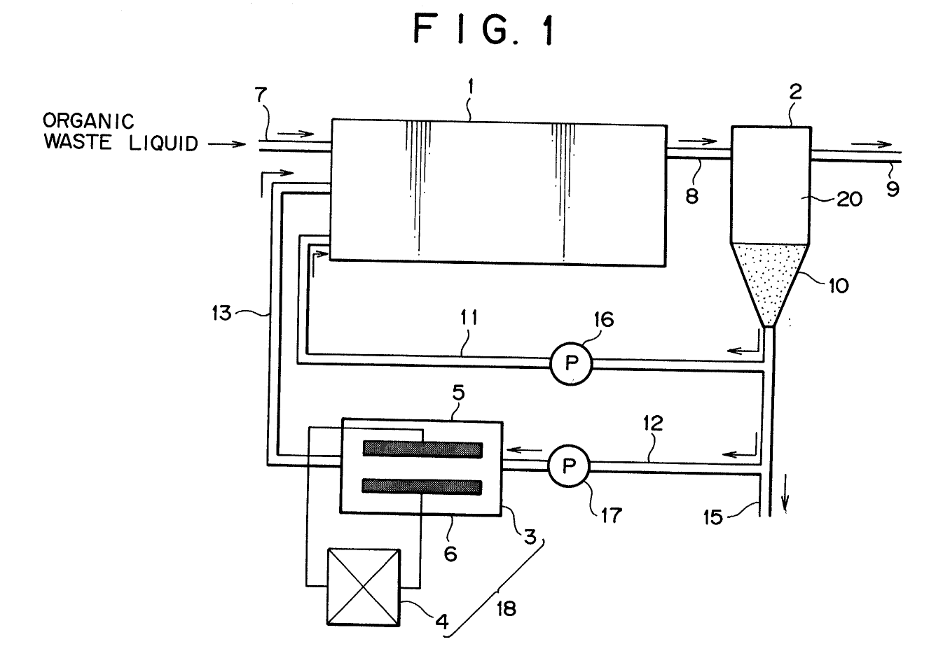

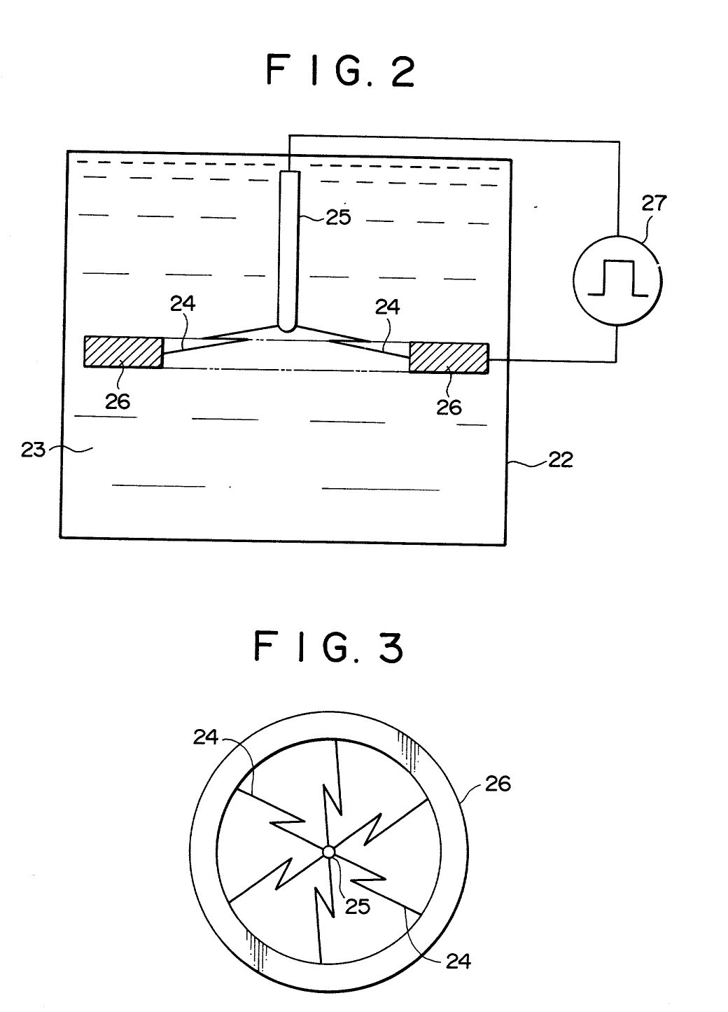

FIG. 2 is a schematic diagram showing one example of the arrangement state and the discharge state of electrodes in the high voltage treatment equipment according to the present invention. In the figure, reference numeral 22 designates a reforming tank; 23 a treated liquid; 24 a discharge; 25 a rod electrode; 26 a plate electrode in a ring-like shape; and 27 a pulsed power power supply. FIG. 3 is an explanatory view of the rod electrode 25 and the plate electrode 26 shown in FIG. 2 as viewed from top. In the equipment, the reforming tank 22 corresponds to the reforming tank 3 shown in FIG. 1.

In the equipment constitution shown in FIG. 2, the rod electrode 25 on the anode side and the plate electrode 26 on the cathode side are arranged coaxially whereby the tri-dimensional cubic discharge can be done with respect to the treated liquid 23 within the reforming tank 22. The shape of the electrode is not limited to those shown. It is preferred that the electrode on the cathode side has at least in its part a circular arc shape such as semi-annular, cylindrical or semi-cylindrical shape, so that the discharge state is widened. However, adoption of an electrode in a flat plate or a rod shape is not excluded, as the plate electrode 26. Further, while in the equipment constitution shown in FIG. 2, a pair of electrodes comprising the rod electrode 25 and the plate electrode 26 are shown, it is to be noted that two or more pair of electrodes can be also provided. Further, in the equipment constitution as shown in FIG. 2, both the rod electrode 25 on the anode side and the plate electrode 26 on the cathode side are dipped into the treated liquid. Furthermore, the rod electrode 25 may be arranged so that discharge may be made from the end thereof as shown in FIG. 2, or may be made from location other than the end of the rod electrode.

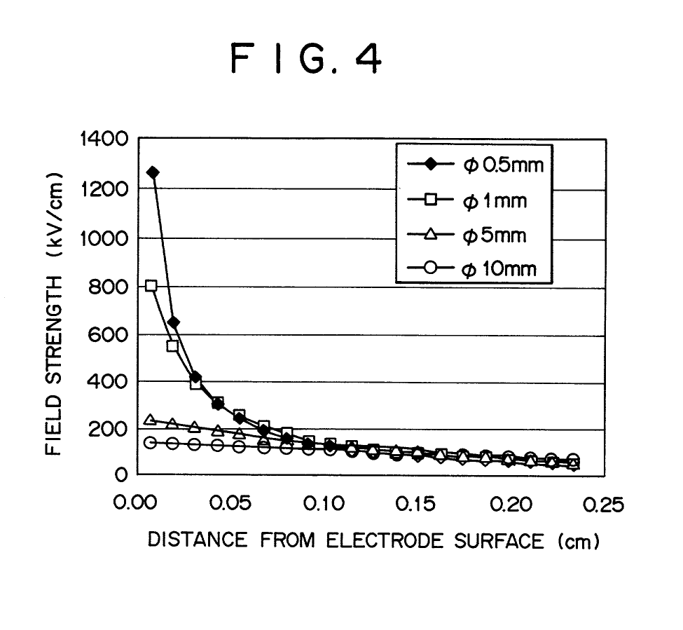

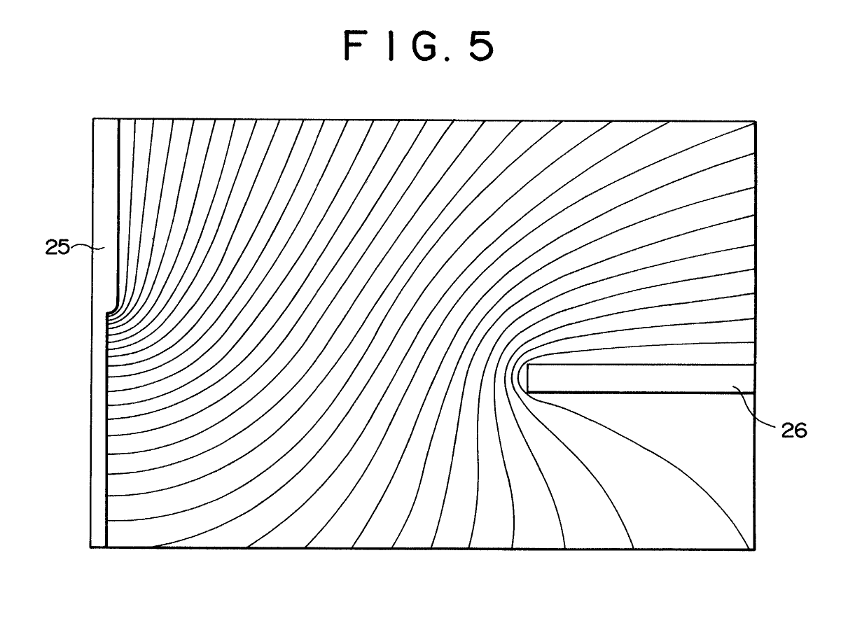

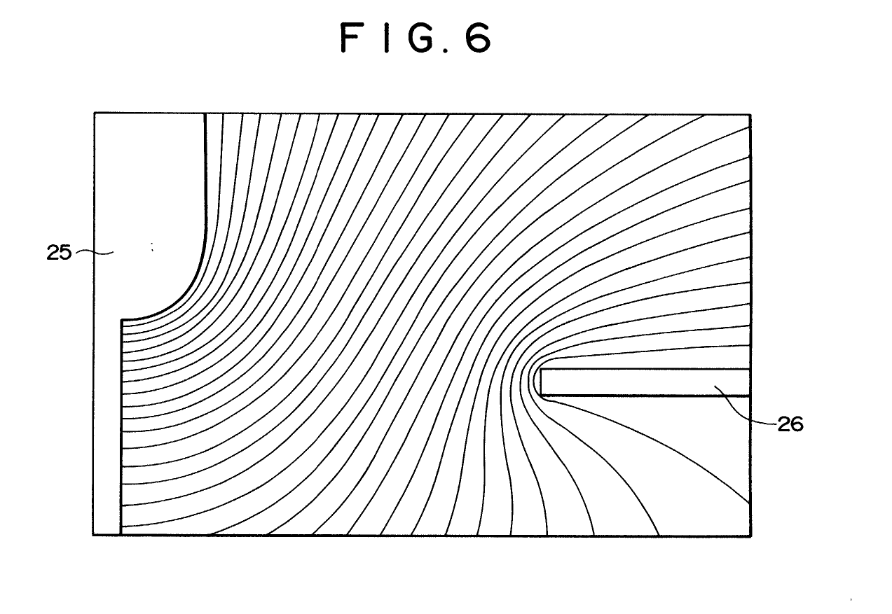

In the high voltage treatment equipment shown in FIG. 2, the study was made how the field strength generated in the vicinity of the electrode when the diameter of the rod electrode 25 on the anode side changes. FIG. 4 is a graph showing the influence of the diameter of the rod electrode 25 on the relationship between the distance from the electrode surface and the field strength. Further, FIG. 5 (equipotential view) shows the distribution of the field strength between the rod electrode 25 and the plate electrode 26 when the diameter of the electrode 25 is 1 mm φ, and FIG. 6 (equipotential view) shows the distribution of the field strength between the rod electrode 25 and the plate electrode 26 when the diameter of the electrode 25 is 10 mm φ. In either case, the applied voltage by the pulsed power power supply 27 is 70 kV. A plurality (29) of curves in FIGS. 5 and 6 show the equipotential, and potential differences adjacent to each other (that is, potential difference of the equipotential) are all equal (70/30 kV).

As will be apparent from these results, it is understood that making the diameter of the rod electrode 25 as small as possible is effective in enhancing the field strength. This means that the streamer can be extended by the lower power supply voltage than that of prior art, and can be extended easily widely. As a consequence, the supplied voltage from the power supply voltage can be lowered than that of prior art, or when the power supply voltage is set to the same as prior art, the streamer discharge is widened in a wide region whereby the discharge treatment region is widened, the treatment amount per unit energy is increased, and the energetic waste can be restricted.

In the high voltage treatment equipment shown in FIG. 2, the pulsed power supply 27 used is preferred to supply voltage not more than 100 kV in terms of size and costs. For achieving the field strength greater than 500 kV/cm in the state that such voltage is applied, the diameter of the rod electrode 25 on the anode side is preferably not more than 1 mm. That is, when the voltage of pulsed power applied between the pair of electrodes 25 and 26 is not more than 100 V, the diameter of the rod electrode 25 on the anode side is not more than 1 mm whereby the field strength in the vicinity of the rod electrode 25 can be enhanced to the field strength greater than 500 kV/cm. It is noted that the distance between the rod electrode 25 and the plate electrode 26 is decided depending upon the voltage applied, and may be suitably set in consideration of the magnitude of voltage applied.

As described above, in the high voltage treatment equipment according to the present invention, the diameter of the rod electrode 25 is made as small as possible, whereby the aforesaid effect is achieved, but forming the end of the rod electrode 25 semispherical is preferable in terms of further enhancing the effect of the present invention.

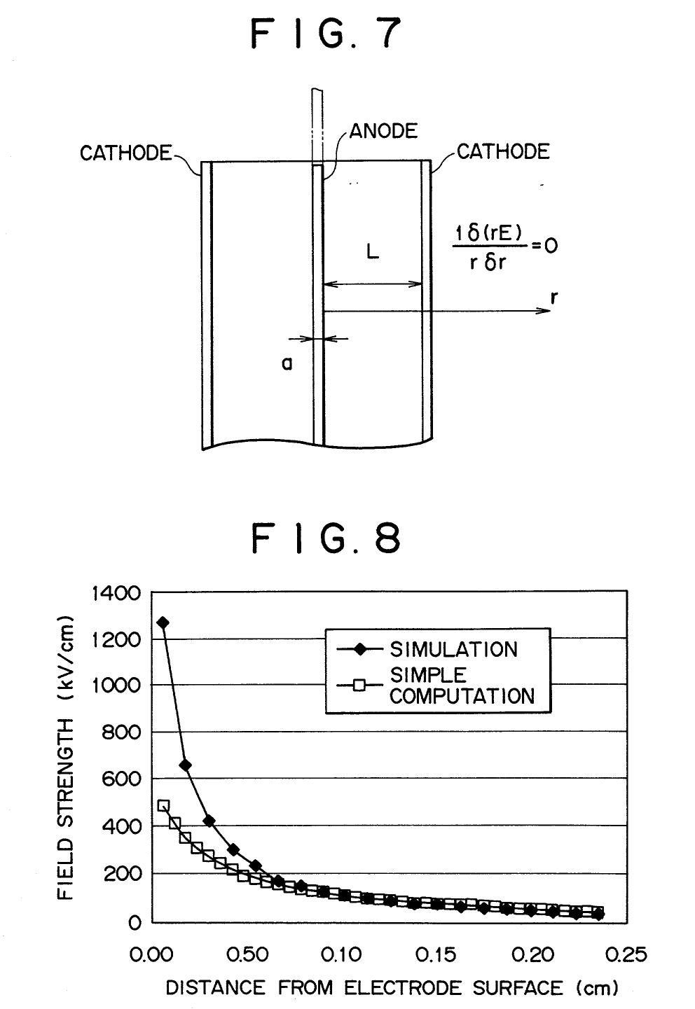

FIG. 7 is a view for explaining the field strength between the anode and cathode, showing the state that a rod-like anode having the radius a (m) whose length can be regarded as the infinite is inserted into a cylindrical cathode having the inside diameter L (m). In the state shown, let r be the distance from the anode center when the field strength is 0, and V the potential difference between anode/cathode, the field strength E(r) between anode/cathode is expressed by the following equation (1):

E(r)=[V/log (L/a)]·(1/r) (1)

Hereupon, using the equipment shown in FIG. 2, the field strength was actually measured (simulated) under the conditions that anode diameter: 0.25 (mm), cathode inner diameter: 25 (mm), and the end of the rod electrode 25 is hemispherical. The relationship between the distance from the electrode surface and the field strength at that time is shown in FIG. 8. FIG. 8 also shows the result of simple computation done on the basis of the Equation (1).

As will be apparent from the result, it is understood that the case of the simulation indicates higher value than that of the case of the simple computation. This was contemplated that in the case of the simple computation, no shape of the end of the rod electrode 25 is taken into consideration. That is, it is understood that making the end of the rod electrode 25 hemispherical is effective in enhancing the field strength.

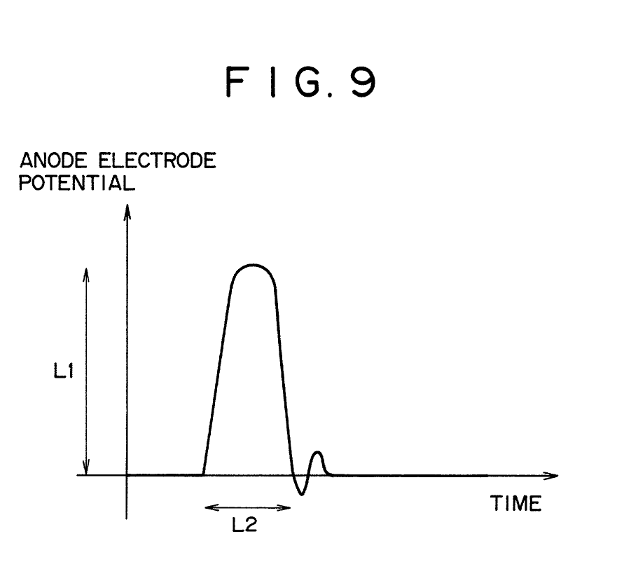

The present inventors have confirmed, in the equipment shown in FIG. 2, the discharge state when the diameter of the rod electrode 25 is changed, and the pulsed power shown in FIG. 9 (in the figure, L1: 100 kV, L2: 1 μsec.) is applied to the anode side. At this time, the inside diameter of the plate electrode was 50 mm, and the diameter of the rod electrode 25 was 1 mm φ or 10 mm φ. As a result, when the diameter of the rod electrode 25 was 1 mm φ, the field strength in the vicinity of the anode was greater than 500 kV to achieve the wide streamer discharge, but when the diameter of the rod electrode 25 was 10 mm φ, the field strength in the vicinity of the anode was not more than 500 kV to fail to obtain the excellent streamer discharge.

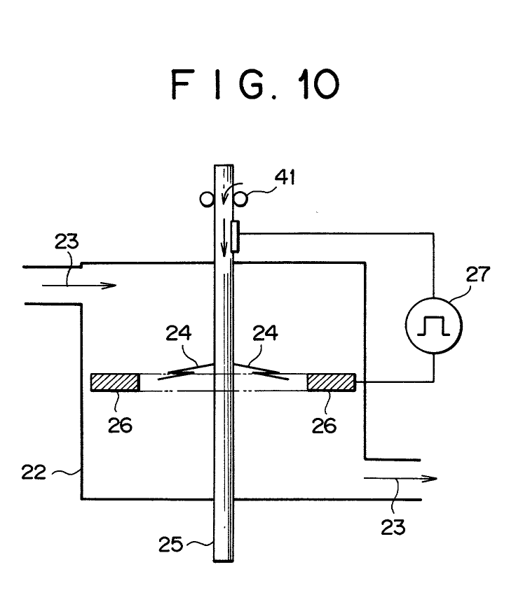

FIG. 10 is a schematic diagram showing a further constitutional example of the present invention, employing a feed-in part 41. In FIG. 10, a movably constituted electrode is the rod electrode 25, and a stationarily arranged electrode is the ring-like plate electrode 26, the rod electrode 25 being arranged coaxially with the ring-like plate electrode 26. When a steep rising pulse voltage is applied between the rod electrode 25 and the ring-like plate electrode 26 from the pulsed power supply 27, a face-like discharge 24 is generated. As described above, the treated liquid 23 present between the electrodes is reformed by the discharge 24. When operation is made with the pair of electrodes in the reforming tank 22 fixed, the discharge generation part of the rod electrode 25 is not changed and electrical stimulation is always imparted to the same part, thus resulting in consumption and damage of the electrode and finally cutting thereof. When the electrode is damaged or cut, the distance between the residual rod-like electrode and the ring-like electrode becomes large, whereby the discharge becomes unstable or finally the discharge stops. Further, when the discharge is attempted to carry out, it is necessary to increase the applied voltage, thus deteriorating the energy efficiency. Therefore, when operation is made such that the feed-in part 41 is actuated whereby for example, the rod electrode 25 shown along with the rod electrode 25 is fed in a direction indicated by arrow into the reforming tank 22 continuously or intermittently, the discharge part of the electrode is moved, thus enabling prevention of damage or cutting to obtain the stable discharge for a long period of time. Further, since no local breakage or destruction of the electrode occurs, the voltage necessary for maintaining the discharge need not be increased more than as needed, no burden is imposed on the power supply, and the excellent energy efficiency can be maintained.

Note that the rod electrode 25 may be constituted so as to be not only fed into the reforming tank 22 but also pulled out thereof, or feeding-in and pulling-out may be done alternately (not shown). Further, constitution is within the scope of the present invention, in which the rod-like electrode and the ring-like electrode are used, and both of them are moved. Further, in the constitution shown in FIG. 10, it is supposed that both the electrodes are dipped into the treated liquid, but for achieving the object of the present invention, either electrode may be in the state of being dipped into the treated liquid. In short, operation may be carried out so that the treated liquid is present in at least the discharge generation portion. However, in a viewpoint of stability of discharge, it is preferable that both of the electrodes are dipped.

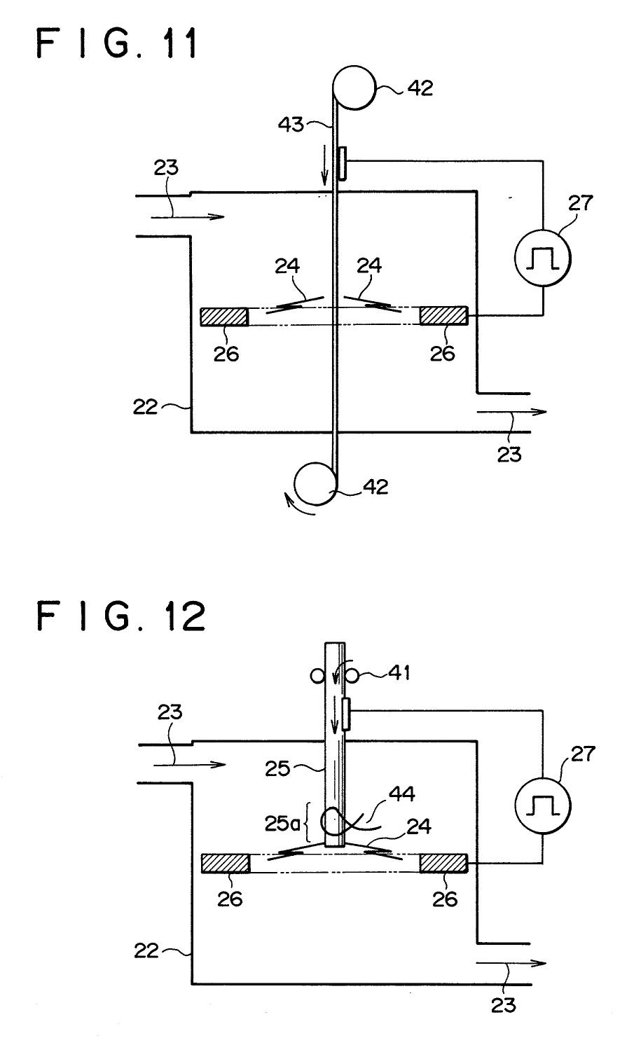

FIG. 11 is a schematic explanatory view showing another constitutional example of the present invention, which is the same in constitution as that shown in FIG. 10 except use of a winding part 42 and a linear electrode 43, equivalent parts being indicated by the same reference numerals. In the constitution using the linear electrode 43, the constitution such as feeding-in or pulling-out may be employed as shown in FIG. 10, but since the electrode is small in diameter, winding constitution can be also employed. When the linear electrode 43 is wound continuously or intermittently by operation of the winding part 42, the discharge generation part can be changed to avoid that the discharge occurs in the same location of the linear electrode 43, thus preventing the electrode from being damaged or cut. Further, employment of winding enables to house the electrode in compact, thus saving the space for the whole liquid treatment equipment.

Further, making the linear electrode 43 as thin as possible in diameter is effective in enhancing the field strength. It is possible to extend the streamer with lower power supply voltage than that of prior art and that is easily extended in a wide region. As a result, the supplied voltage from the power supply can be lowered than prior art, or when the power supply voltage is made the same as that of prior art, the streamer discharge is expanded in a wide region, whereby the discharge treatment region is widened to increase the treatment amount per unit energy, thus reducing energetic waste. It is suggested from a viewpoint of the foregoing that the diameter of the linear electrode 43 be not more than 1 mm.

FIG. 12 is another constitutional example of the present invention, showing that the rod electrode 25 is not extended through the reforming tank 22, but the end of the linear electrode is dipped into the treated liquid. In this constitution, the rod electrode 25 is moved by operation of the feeding-in part 41 whereby the electrode can be prevented from being consumed. Even if the discharge is repeated for a long period of time, the stabilized discharge can be obtained for a long period of time. Further, interventions such as hair or dust are sometimes mixed, and interventions become entangled in the discharge generation part of the electrode. However, by employment of the constitution as shown in FIG. 12, the interventions 44 can be easily escaped from bottom of the end 25a of the rod electrode, thus enabling reduction in entanglement of the interventions 44 to the electrode. Further, when the treated liquid 23 causes to flow in the same direction as or in the direction opposite to the feeding-in direction of the rod electrode 25, the interventions 44 can be easily removed by the flow of the treated liquid 23. Further, the flowing direction of the treated liquid 23 in the reforming tank 22 is suitably changed, whereby the intervention entangled in the rod electrode 25 or the intervention stayed in the reforming tank 22 can be removed.

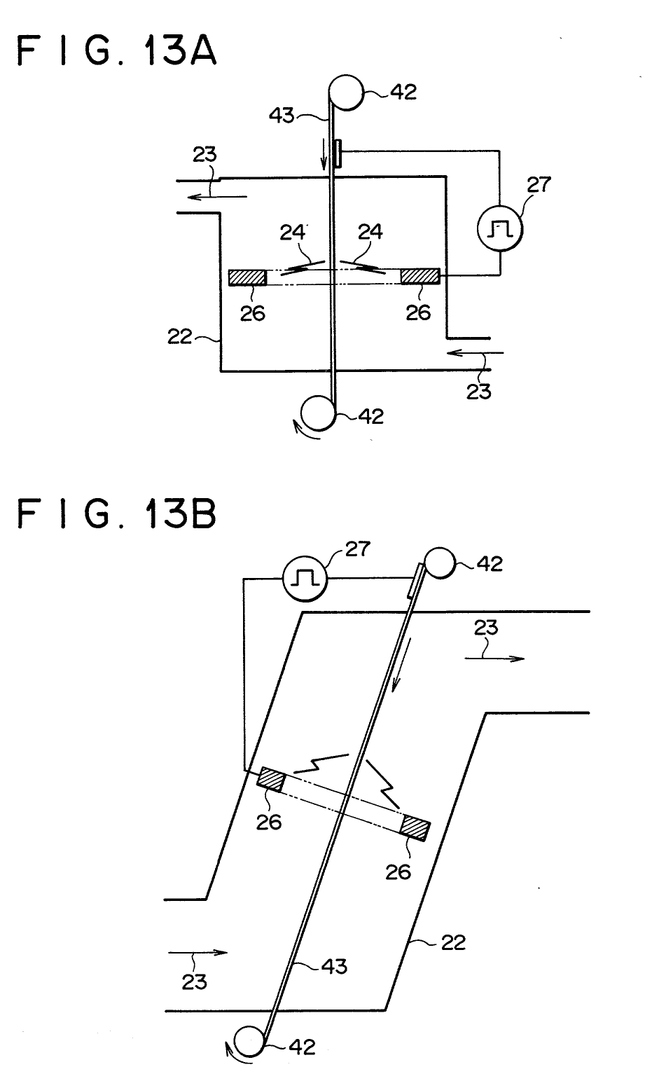

Since the discharge occurs even in air, even if discharge is carried out in a state that at least one electrode out of the pair of electrodes is dipped into treated liquid, the treated liquid present between the electrodes can be treated. However, since when the discharge in air occurs, not only consumption of electrodes is large but also impedance at the time of discharge is small, it results in imposing the burden on the power supply. It is effective that when the flow of the treated liquid 23 is directed from top to bottom of the reforming tank 22, the distance between the discharge generation part and the inlet port of the treated liquid is made long so that bubbles generated when the treated liquid is introduced is hard to enter the discharge generation part in order to prevent bubbles from staying in the discharge generation part of the electrode (not shown). Further, when constitution is employed in which the flow of the treated liquid 23 is directed from bottom to top of the reforming tank 22 as shown in FIG. 13A, a water amount (water level) in the reforming tank 22 is easily adjusted to control such that the treated liquid is caused to flow continuously or intermittently so as not to have air stayed in the discharge region. Further, it is effective that the reforming tank 22 is inclined as shown in FIG. 13B, and when constitution is employed so that the treated liquid flows from bottom to top of the reforming tank 22, the treated liquid flows smoothly to obtain the effect similar to that mentioned above.

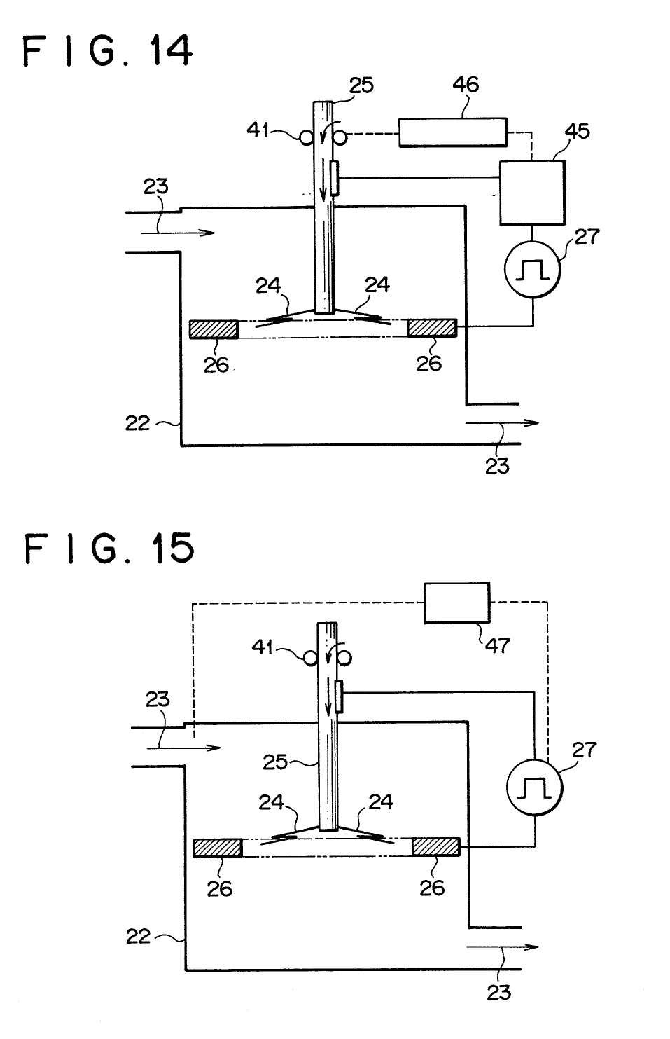

FIG. 14 shows equipment similar to that shown in FIG. 12, which is liquid treatment equipment comprising means for measuring a discharge voltage or a discharge current 45 to the treated liquid 23, and a control device 46 for controlling speeds for feeding the rod electrode 25 on the basis of variation of the measured value.

The streamer discharge maintains the discharge in a state that voltage is high, and the arc discharge maintains the discharge in a state that the voltage is low and the current is high. Therefore, in a case where the streamer discharge is changed to the arc discharge, the voltage between anode and cathode in the discharge part rapidly lowers. So, the lowered voltage (for example, about 1 to 10 kV) is detected to control the speed for feeding the rod electrode 25, whereby an inconvenience caused by consumption or cutting of the electrodes can be avoided, and the change from the streamer discharge to the arc discharge can be prevented or the change to the arc discharge can be minimized to avoid the generation of the state that the streamer discharge and the arc discharge are mixed. Further, by employment of the above constitution, reforming of the treated liquid can be achieved with less power, which is highly effective and advantageous in economy.

Further, since the voltage is low at the time of the streamer discharge and the arc discharge is maintained in a state that the current is high, in a case where the streamer discharge is changed to the arc discharge, a current flowing to a treatment container 33 rapidly increases. This increase in current (for example, not less than 300 to 500 Å) may be detected, and the speed for feeding the rod electrode 25 is controlled in response to the detection whereby the inconvenience caused by consumption or cutting of the electrode can be avoided, and the change from the streamer discharge to the arc discharge can be prevented or the change to the arc discharge can be minimized to avoid the generation of the state that the streamer discharge and the arc discharge are mixed.

FIG. 15 shows the constitutional example provided with means for measuring a flow rate 47 of treated liquid 23 in the constitutional example in FIG. 12. When the flow rate of the treated liquid 23 flowing into the reforming tank 22 becomes reduced or stopped, a vapor phase is formed in a discharge region between the pair of electrodes into an air discharge. When the air discharge occurs, the consumption of the electrodes increases as described above. For the purpose of avoiding this, the flow rate of the treated liquid 23 is measured, and when the reduction in flow rate of the treated liquid 23 in the reforming tank 22 is detected, the discharge is stopped to avoid the air discharge or to avoid the wasteful discharge. The flow meter may be means for measuring a water level of the treated liquid 23 in the reforming tank 22 or means for detecting bubbles present in a pair of electrode arrangement portion. When judgment is made that the treated liquid is not present in the pair of electrode arrangement portion, operation may be stopped.

Further, the flow meter may be means for measuring conductivity or impedance of the treated liquid. Interval of discharge between the pair of electrodes or applied voltage is controlled or stopped on the basis of the value of conductivity or impedance of the treated liquid varied by the discharge treatment whereby liquid treatment adjusted to the concentration (treatment amount) of the treated liquid can be applied to reduce the consumption of extra energy.

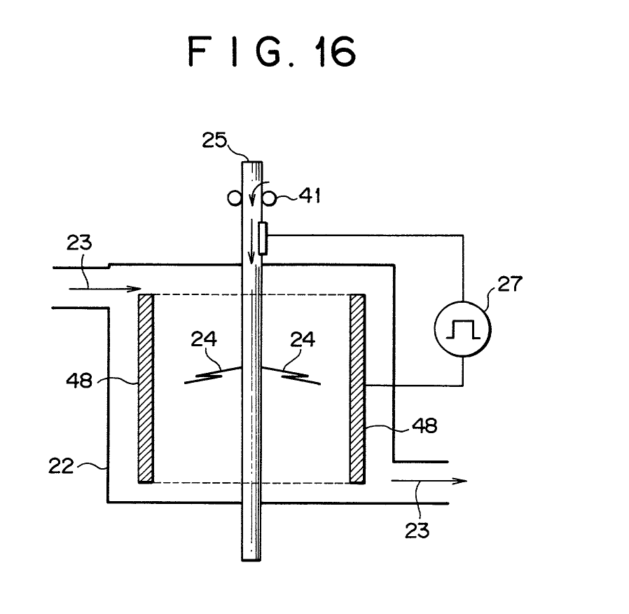

It is noted that pulsewise power supplied from the high voltage power supply is not limited to square waveform, but rectangular waveform, sine waveform or triangular waveform may be applied. Further, while as described above, the constitutional example is shown which uses a ring-like electrode for one electrode, a tubular electrode may be used in place of the ring-like electrode as shown in FIG. 16, whereby an area that can be applied with treatment is enlarged to thereby enable applying discharge treatment to the treated liquid more effectively. Further, while the constitution in which one pair of electrodes is provided in the reforming tank, it is noted that two or more sets of electrodes can be also provided.

Material for electrodes is not particularly limited, but Fe (iron) or W (tungsten) is preferably used. Further, electrodes may be replaced depending upon a degree of consumption.

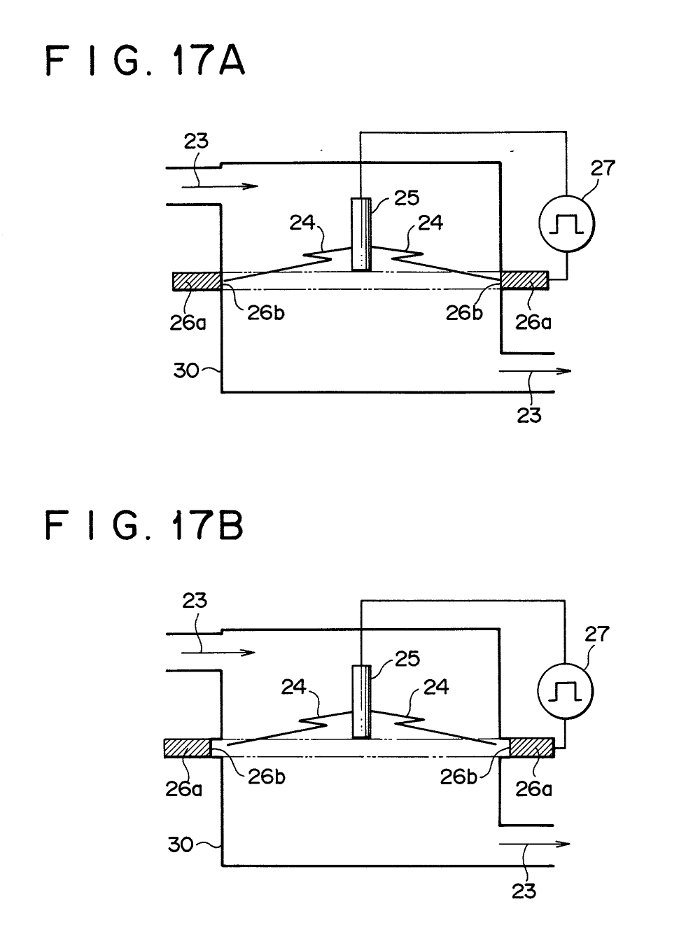

FIGS. 17A and 17B are schematic diagrams schematically showing other constitutional examples of the equipment according to the present invention. A pipeline 30 shown in FIGS. 17A and 17B corresponds to the reforming tank 22.

The equipment shown in FIG. 17A is constituted so that a ring-like electrode 26a is embedded in the wall surface of a pipeline 30 leaving the electrode inner surface 26b. According to the constitution as described, since the surface of the ring-like electrode 26a, the electrode surface vertical to the flowing direction of the treated liquid 23 is present in the inner wall of the pipeline 30, and therefore the pressure loss of the treated liquid 23 caused by the ring-like electrode 26a can be reduced. Further, since the ring-like electrode 26a is hardly projected from the pipeline 30, dust or the like is not adhered to the electrode. Accordingly, trouble for removing dust adhered to the ring-like electrode 26a can be saved. The “embedded” termed hereupon means the state that the inner surface 26a of the ring-like electrode 26a is provided on the pipeline inner wall so as to come in contact with the treated liquid 23, and as shown in FIG. 17B, the ring-like electrode 26a may be somewhat sunk into the pipeline 30. However, if the dent portion produced in the wall surface of the pipeline 30 is large, dust is accumulated on the dent portion or the pressure loss is generated, and additional care is needed.

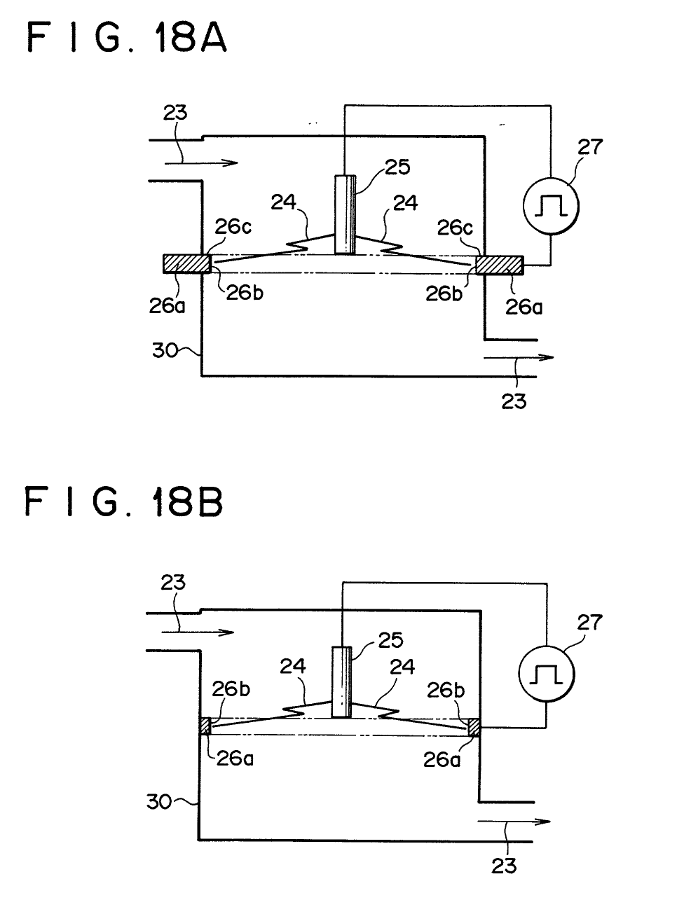

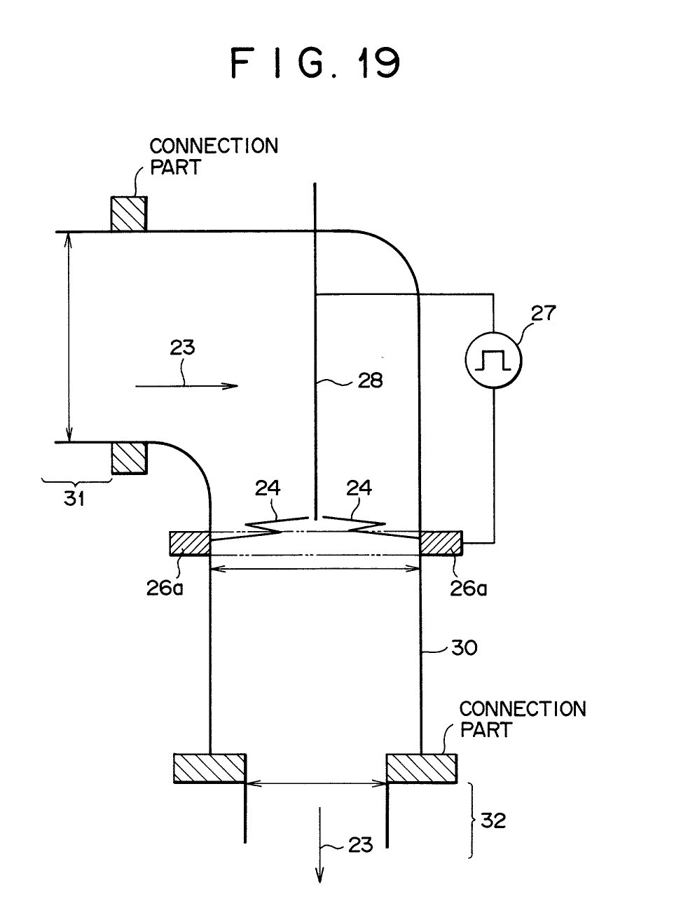

FIGS. 18A and 18B are schematic diagrams showing other constitutional examples of the equipment according to the present invention, in which the ring-like electrode 26a shown in FIGS. 17A and 17B is constituted so that a plane part 26c as viewed in an axial direction of the ring-like electrode 26a is not substantially exposed from the inner wall of the pipeline 30. That is, the ring-like electrode 26a is embedded so as not to be exposed substantially into the pipeline 30, as shown in FIG. 18A, or the thin ring-like electrode 26a comes into the inner wall surface of the pipeline 30 as shown in FIG. 18B so that the electrode 26a is not substantially exposed into the pipeline 30. The “substantially” termed hereupon means that if the degree is a degree of not adhering dust to a part of the ring-like electrode 26a projected from the pipeline 30 or not imparting pressure loss to the treated liquid 23 by the projected portion, a slight projection can be allowed. Concretely, a difference between the inner surface 26b of the ring-like electrode 26a and the inner wall of the pipeline 30 may be not more than about 10 mm.

FIG. 19 is a schematic diagram schematically showing another constitutional example according to the present invention, which is the same as FIG. 17 except that a linear electrode 28 is used in place of the rod-like electrode, and that a difference in level is not produced in a connection part between the pipeline 30 and a treated liquid inlet pipe 31. The treated liquid inlet pipe 31 equal to the inside diameter of the pipeline 30 is connected whereby the difference in diameter produced in the connection part can be eliminated, and therefore, the quantity of dust accumulated in the difference in diameter portion can be reduced, and the pressure loss of the treated liquid 23 caused by the difference in diameter can be reduced. For example, as will be understood from FIG. 19, when the inside diameter of the pipeline 30 is different from that of the treated liquid outlet pipe 32, a difference in diameter is produced in the connection part, and therefore, dust is accumulated on the difference in diameter portion, and the pressure loss of the treated liquid 23 is produced.

In FIG. 19, it is constituted so that the difference in diameter produced in the connection part between the pipeline 30 and the treated liquid inlet pipe 31 is eliminated, but it may be constituted so that the difference in diameter produced in the connection part between the pipeline 30 and the treated liquid outlet pipe 32 is eliminated (not shown). Most preferable constitution is that a difference in diameter produced in both connection parts between the pipeline 30 and the treated liquid inlet pipe 31 and between the pipeline 30 and the treated liquid outlet pipe 32 may be eliminated.

Further, in FIG. 19, by using the linear electrode 28, the reforming efficiency of the treated liquid can be enhanced. That is, since the linear electrode is thinner than a rod electrode, it is effective in enhancing the field strength, and the streamer can be extended with lower power supply voltage than that of prior art, and can be easily extended in a wide region. As a result, the supplied voltage from the power supply can be lowered than that of prior art, or when the power supply voltage is made the same as that of prior art, the streamer discharge is extended in a wide region whereby the discharge treatment region is enlarged, the treatment amount per unit energy increases, and the energetic waste can be suppressed. It is recommended from a viewpoint of the foregoing that the diameter of the linear electrode 28 be not more than 1 mm φ.

While in the above-described embodiments, the rod electrode 25 and the linear electrode 28 have been shown as the electrodes pair of with the ring-like electrode, it is to be noted that the pair of electrodes are not particularly limit as long as they are linear electrodes whose shape is linear. Therefore, the sections illustrated are circular, triangular, square and polygonal in shape. Further, the linear electrode may be hollow or solid, but preferably, the solid electrode is employed from a viewpoint of durability.

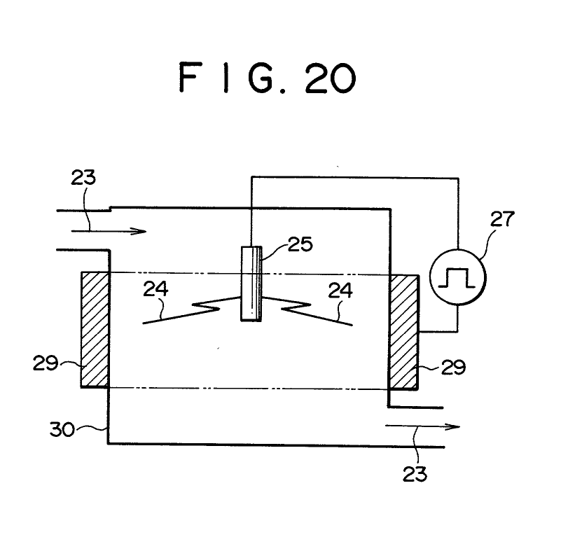

Further, while in FIGS. 17 to 19, a description has been made using the ring-like electrode, it is noted that preferably, a tubular electrode 29 may be used in place of the ring-like electrode as shown in FIG. 20. When the tubular electrode 29 is employed, the discharge surface is further enlarged, and the reforming efficiency of the treated liquid can be enhanced.

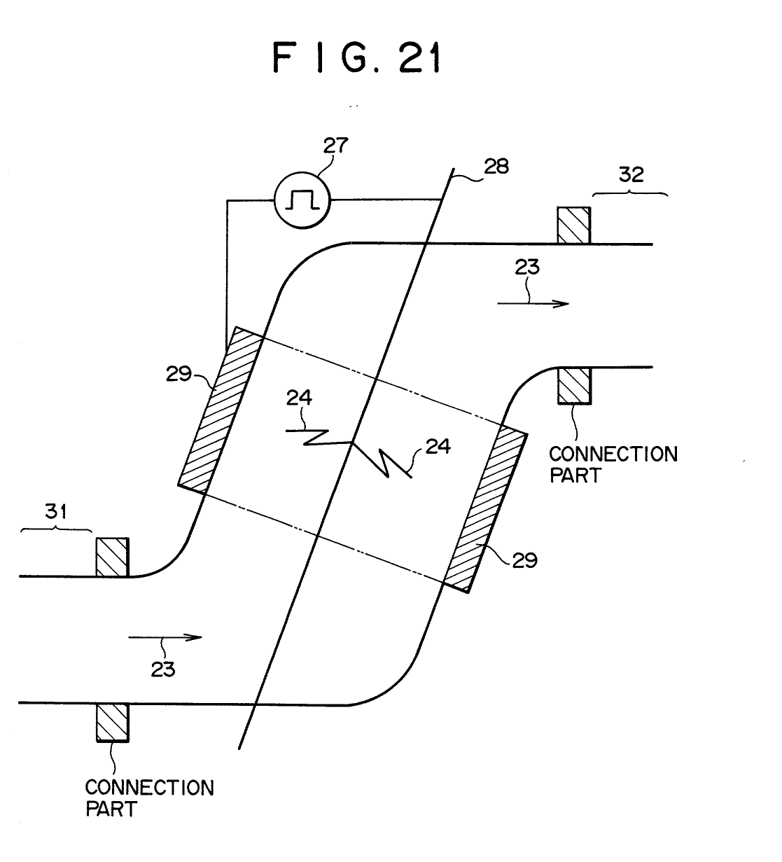

In the present invention, the method for flowing the treated liquid is not particularly limited, but it may cause to flow continuously or to flow intermittently. Further, the direction for flowing the treated liquid is not particularly limited as long as the direction is approximately vertical to the radius direction of the ring-like or tubular electrode. For example, FIG. 21 is a schematic diagram showing still another constitutional example of the present invention, which is constituted so that a pipe 30 provided with a linear electrode 28 and a tubular electrode 29 is inclined with respect to a horizontal surface, and the treated liquid is caused to flow from bottom to top. The treated liquid is caused to flow from bottom as described whereby a water level of the treated liquid can be easily controlled, and the possibility of producing an air discharge between the linear electrode 28 and the tubular electrode 29 can be reduced.

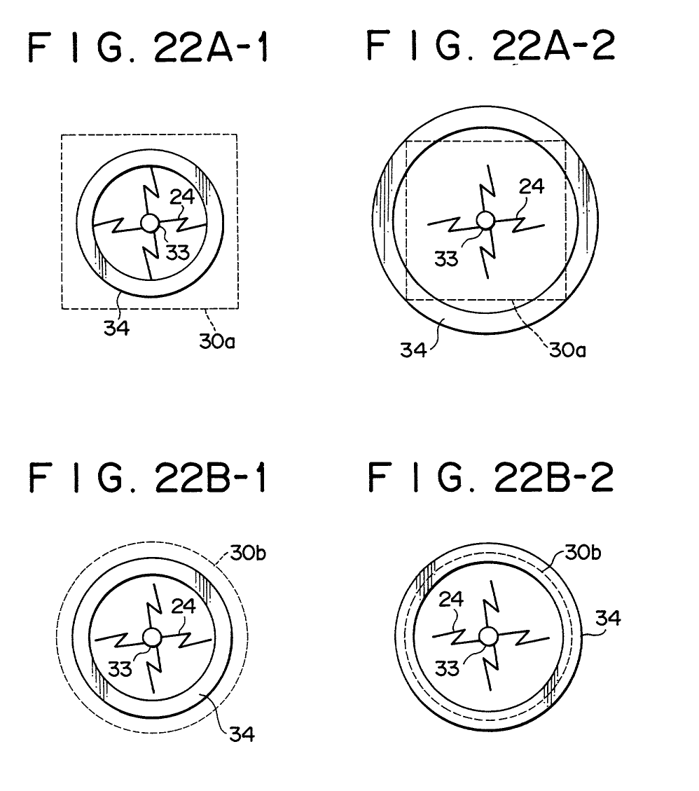

Further, the sectional shape of the pipeline used in the present invention is not particularly limited, but a circular shape is recommended. For example, as will be understood from FIGS. 22A-1 (prior art) and 22A-2 (the present embodiment), in a case of the pipeline 30a whose sectional shape is square, even if the ring-like or linear electrode 34 is constituted so that a plane part as viewed in an axial direction of the ring-like or tubular electrode 34 is not exposed as less as possible into the pipeline inner wall, since the sectional shape is different in shape from the square pipeline 30a, a portion of the ring-like or tubular electrode 34 into the pipeline 30a increases. That is, it is not possible to obtain the effect of the present invention sufficiently.

On the other hand, as shown in FIGS. 22B-1 and 22B-2, when the pipeline 30 whose sectional shape is circular is used, since the ring-like or tubular electrode 34 is also circular in sectional shape, the ring-like or tubular electrode 34 is arranged as shown in the present embodiment (FIG. 22B-1) example whereby the ring-like or tubular electrode 34 is not substantially exposed into the pipeline 30b, as compared with the arrangement of the ring-like or tubular electrode 34 into the pipeline 30b as shown in the prior art (FIG. 22B-2). Accordingly, it is possible to reduce the pressure loss of the treated liquid caused by the ring-like or tubular electrode 34 and to reduce the quantity of dust adhered to the electrodes.

While in the present invention, material for electrodes is not particularly limited, those such as Fe (iron) or Cu (copper) can be used, but from a viewpoint of consumption of electrodes, stainless steel or tungsten, which have relatively high melting points, is preferably used.

1. A high voltage treatment equipment for liquid comprising:
a pair of electrodes, at least one electrode out of said pair of electrodes being arranged so as to be dipped into liquid; and
means for applying a pulsed power between electrodes of said pair of electrodes,
wherein said pair of electrodes are constituted so that a region whose field strength is raised to a value larger than 500 kV/cm is present in the vicinity of at least one electrode dipped into said liquid.

2. A high voltage treatment equipment for liquid comprising:
a pair of electrodes, at least one electrode out of said pair of electrodes being arranged so as to be dipped into liquid; and
means for applying a pulsed power between electrodes of said pair of electrodes,
wherein at least one electrode dipped into said liquid is a rod-like electrode whose diameter is not more than 1 mm.

3. The high voltage treatment equipment for liquid according to claim 2, wherein voltage of said pulsed power is not more than 100 kV.

4. The high voltage treatment equipment for liquid according to claim 2, wherein an extreme end of said rod-like electrode is formed to be hemisphere.

5. The high voltage treatment equipment for liquid according to claim 2, wherein said rod-like electrode is an anode electrode.

6. A high voltage treatment method for liquid comprising:
using a pair of electrodes, at least one electrode out of said pair of electrodes being arranged so as to be dipped into liquid; and
applying a pulsed power not more than 100 kV between said pair of electrodes to form a discharge state in said liquid between said pair of electrodes,
wherein said liquid is treated so that a region whose field strength is raised to a value larger than 500 kV/cm is present in the vicinity of at least one electrode dipped into said liquid.

7. The high voltage treatment method for liquid according to claim 6, wherein one electrode dipped into said liquid is a rod-like electrode whose diameter is not more than 1 mm.

8. A high voltage treatment equipment for liquid comprising:
a pair of electrodes, at least one electrode out of said pair of electrodes being arranged so as to be dipped into liquid;
means for applying a pulsed power between electrodes of said pair of electrodes; and
a movement mechanism for moving at least one electrode dipped into said liquid so as to change a relative position with respect to the other electrode.

9. The high voltage treatment equipment according to claim 8, wherein one of said pair of electrodes is a rod-like or linear electrode.

10. The high voltage treatment equipment according to claim 9, wherein the other electrode separately from the rod-like or linear electrode of said pair of electrodes is a tubular or ring-like electrode, and a relative positional relationship between said rod-like or linear electrode and said tubular or ring-like electrode can be changed while maintaining a state that said rod-like or linear electrode passes a center point or an axial center of said tubular or ring-like electrode.

11. The high voltage treatment equipment according to claim 10, wherein an end of said rod-like or linear electrode is positioned in the vicinity of the tubular or ring-like electrode.

12. The high voltage treatment equipment according to claim 10 wherein, said rod-like or linear electrode is moved by said movement mechanism.

13. The high voltage treatment equipment according to claim 12, wherein said movement mechanism is a winding mechanism, which winds the linear electrode.

14. The high voltage treatment equipment according to claim 8, further comprising:
means for measuring a discharge voltage or a discharge current to said liquid; and
control means for controlling a movement speed of a relative position of an electrode by said movement mechanism on the basis of the value measured by said means for measuring a discharge voltage or a discharge current.

15. The high voltage treatment equipment according to claim 8, further comprising:
means for measuring the flow rate, conductivity or impedance of said liquid; and
control means for controlling a value of voltage applied by said means for applying the high voltage on the basis of the value measured by said means for measuring the flow rate, conductivity or impedance of liquid.

16. The high voltage treatment equipment according to claim 9, wherein the diameter of said rod-like or linear electrode is not more than 1 mm.

17. A high voltage treatment method for liquid comprising:
using a pair of electrodes, at least one electrode out of said pair of electrodes being dipped into liquid; and
applying a pulsed power between electrodes of said pair of electrodes to form a discharge state in said liquid between said pair of electrodes,
wherein a discharge state of said at least one electrode dipped into liquid is continued while changing a relative position with respect to the other electrode.

18. The high voltage treatment method for liquid according to claim 17, wherein said liquid causes to flow continuously or intermittently.

19. The high voltage treatment method for liquid according to claim 18, wherein a flow of said liquid is controlled so that bubbles are not stayed in a discharge generation part of said pair of electrode.

20. The high voltage treatment method for liquid according to claim 2, further comprising a pipeline through which said liquid passes, wherein said rod-like electrode is positioned at an axial center of said pipeline, an electrode separately from said rod-like electrode out of said pair of electrodes is a ring-like or tubular electrode arranged coaxially with the inner peripheral surface of said pipeline and embedded in the wall of said pipeline, and said ring-like or tubular electrode is provided so that a plane part vertical to an axial direction is not exposed substantially to said liquid.

21. The high voltage treatment method for liquid according to claim 20, wherein no difference in diameter is present in a connection part between said pipeline and an inlet or outlet pipe.
